(19) United States
(12) Patent Application Publication
(10) Pub. No.: US 2010/0231560 A1
(43) Pub. Date: Sep. 16, 2010

(54) ELECTRO-OPTICAL APPARATUS, ELECTRONIC DEVICE, AND DRIVING METHOD FOR THE ELECTRO-OPTICAL APPARATUS

(75) Inventors: Takashi TOYOOKA, Matsumoto-shi (JP); Taku KITAGAWA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/722,889

(22) Filed: Mar. 12, 2010

(30) Foreign Application Priority Data
Mar. 13, 2009 (JP) 2009-060749

(51) Int. Cl. G06F 3/038; G09G 3/20

(52) U.S. Cl. 345/205; 345/55

(57) ABSTRACT

An electrophoretic display apparatus, electronic device, and driving method for an electrophoretic display apparatus are capable of significantly increasing the number of tones that can be expressed in a single frame period. The electrophoretic display apparatus divides at least part of a frame period into multiple subfield periods and controls the light transmission of an electro-optical layer by selecting, on a subfield period-by-subfield period basis, an on or off voltage as the driving voltage to apply between a pixel electrode and an opposing electrode to display multiple tones. A driving circuit of the electrophoretic display apparatus determines, in accordance with the tone to be displayed, the ratio between the application periods of the on and off voltages during the frame period, and the arrangement of the on and off voltages. The absolute values of the positive-polarity and negative-polarity voltages are different from each other.

The entire disclosure of Japanese Patent Application No. 2009-060749, filed Mar. 13, 2009 is expressly incorporated by reference herein.

### BACKGROUND

1. Technical Field

The present invention relates to an electro-optical apparatus, an electronic device, and a driving method for the electro-optical apparatus.

2. Related Art

A liquid crystal apparatus will be described as an example of an electro-optical apparatus.

Subfield driving has been known for some time as a driving method for a liquid crystal display apparatus (for example, see JP-A-2007-148417).

With subfield driving, a single frame period is divided into multiple subfield periods. The on/off state of the liquid crystal is controlled on a subfield-by-subfield basis. Through this, a tonal display can be realized in the liquid crystal apparatus.

Incidentally, the aforementioned JP-A-2007-148417 discloses inverting the data write polarity on a frame-by-frame basis and applying an equal driving voltage with those respective polarities.

Furthermore, the aforementioned JP-A-2007-148417 discloses determining the on voltage and the off voltage so that the integrated value of transmitted light in a single frame period corresponds to tonal data. It is known that a greater number of subfields in a single frame period generally makes it possible to express a greater number of tones.

However, past liquid crystal apparatuses have been problematic in that it is difficult to further increase the number of tones.

### SUMMARY

Having been achieved in order to solve the aforementioned problem, the invention can be realized as the following aspects or application examples.

### Application Example 1

According to an aspect of the invention, there is provided an electro-optical apparatus including a switching transistor provided at the intersecting point of a scanning line and a data line, a pixel electrode connected to the switching transistor and to which a potential is supplied from the data line via the switching transistor, an opposing electrode, an electro-optical layer to which an electrical field generated between the pixel electrode and the opposing electrode is applied, and a driving circuit that drives the scanning line and the data line, the electro-optical apparatus controlling the light transmission of the electro-optical layer and displaying multiple tones (gray-scales) by dividing at least part of a frame period into multiple subfield periods and by selecting, on a subfield period-by-subfield period basis, one of an on voltage and an off voltage as the driving voltage to apply between the pixel electrode and the opposing electrode in order to generate the optical field, in which the on voltage is selected from among a positive-polarity voltage and a negative-polarity voltage, the positive-polarity voltage being the driving voltage in the case where the potential of the pixel electrode is higher than the potential of the opposing electrode, and the negative-polarity voltage being the driving voltage in the case where the potential of the pixel electrode is lower than the potential of the opposing electrode; the off voltage is the driving voltage in the case where the potential of the pixel electrode is approximately equal to the potential of the opposing electrode; and the driving circuit determines, in accordance with the tone to be displayed, the ratio between the application period of the on voltage and the application period of the off voltage during the frame period and the arrangement of the multiple subfield periods in which the on voltage is to be applied and the arrangement of the multiple subfield periods in which the off voltage is to be applied, and the absolute value of the positive-polarity voltage and the absolute value of the negative-polarity voltage are different.

With this electro-optical apparatus, a driving voltage having absolute values that are different in the subfields in which a positive-polarity voltage is applied and the subfields in which a negative-polarity voltage is applied can be applied to a liquid crystal.

Accordingly, with this electro-optical apparatus, different transmissibilities can be realized in positive-polarity periods and negative-polarity periods, making it possible to increase the number of tones that can be expressed. The amount of light that passes through the electro-optical apparatus (the transmissibility) is determined based on the response state of the electro-optical layer, and this response state is a state that differs depending on the driving voltage that is applied. Accordingly, applying different driving voltages in positive-polarity periods and negative-polarity periods causes the transmissibilities to differ in the positive-polarity periods and negative-polarity periods, thus making it possible to finely adjust the transmissibility in an overall frame period in which the positive-polarity periods and negative-polarity periods are combined, as compared to a configuration in which the driving voltage and transmissibility is the same throughout the positive-polarity periods and negative-polarity periods. This makes it possible to realize transmissibilities that could not be expressed in the past.

### Application Example 2

It is preferable, in the electro-optical apparatus according to the aforementioned application example, for the frame period to include multiple positive-polarity periods in which the positive-polarity voltage is selected as the on voltage and multiple negative-polarity periods in which the negative-polarity voltage is selected as the on voltage, and for the length of the subfield period contained in the positive-polarity period and the length of the subfield period contained in the negative-polarity period to differ from each other.

### Application Example 3

It is preferable, in the electro-optical apparatus according to the aforementioned application example, for the subfield period contained in the positive-polarity period to be longer than the subfield period contained in the negative-polarity period, and for the absolute value of the positive-polarity voltage to be less than the absolute value of the negative-polarity voltage.

### Application Example 4

It is preferable, in the electro-optical apparatus according to the aforementioned application example, for the subfield period contained in the positive-polarity period to be shorter than the subfield period contained in the negative-polarity period, and for the absolute value of the positive-polarity voltage to be greater than the absolute value of the negative-polarity voltage.

According to such a configuration, it is possible to bring the rms of the on voltage in subfield periods contained in the positive-polarity periods and subfield periods contained in negative-polarity periods closer together or make that rms equal, thus making it possible to effectively reduce burn-in.

### Application Example 5

It is preferable, in the electro-optical apparatus according to the aforementioned application example, that in the frame period, the subfield periods in which the positive-polarity voltage is selected as the on voltage and the subfield periods in which the negative-polarity voltage is selected as the on voltage be arranged in an alternating manner. According to such a configuration, when an on voltage is applied across multiple adjacent subfield periods, the transmissibility can be changed depending on whether the multiple subfield periods begin with a positive-polarity period or a negative-polarity period.

### Application Example 6

It is preferable, in the electro-optical apparatus according to the aforementioned application example, that in a first frame period and a second frame period in which the numbers of multiple subfield periods in which the on voltage is applied are equal, the driving circuit arrange the multiple subfield periods in which the on voltage is applied as to the integrated value of the light transmission in the first frame period correspond to a first tone and the integrated value of the light transmission of the second frame period correspond to a second tone that is different from the first tone.

### Application Example 7

It is preferable, in the electro-optical apparatus according to the aforementioned application example, that in the first frame period, the response of the electro-optical layer in a first subfield period in which an on voltage that is the positive-polarity voltage is applied and the response of the electro-optical layer in a second subfield period in which an on voltage that is the negative-polarity voltage is applied affect each other; in the second frame period, the response of the electro-optical layer in a third subfield period in which an on voltage that is the positive-polarity voltage is applied and the response of the electro-optical layer in a fourth subfield period in which an on voltage that is the negative-polarity voltage is applied affect each other; the first subfield period be arranged in a location that is temporally earlier than the second subfield period; and the third subfield period be arranged in a location that is temporally later than the fourth subfield period.

### Application Example 8

An electronic device provided with the electro-optical apparatus according to the aforementioned application example.

### Application Example 9

A driving method for an electro-optical apparatus, the electro-optical apparatus including a switching transistor provided at the intersecting point of a scanning line and a data line, a pixel electrode connected to the switching transistor and to which a potential is supplied from the data line via the switching transistor, an opposing electrode, an electro-optical layer to which an electrical field generated between the pixel electrode and the opposing electrode is applied, and a driving circuit that drives the scanning line and the data line, the electro-optical apparatus controlling the light transmission of the electro-optical layer and displaying multiple tones by dividing at least part of a frame period into multiple subfield periods and by selecting, on a subfield period-by-subfield period basis, one of an on voltage and an off voltage as the driving voltage to apply between the pixel electrode and the opposing electrode in order to generate the optical field, in which the on voltage is selected from among a positive-polarity voltage and a negative-polarity voltage, the positive-polarity voltage being the driving voltage in the case where the potential of the pixel electrode is higher than the potential of the opposing electrode, and the negative-polarity voltage being the driving voltage in the case where the potential of the pixel electrode is lower than the potential of the opposing electrode; the off voltage is the driving voltage in the case where the potential of the pixel electrode is approximately equal to the potential of the opposing electrode; and the ratio between the application period of the on voltage and the application period of the off voltage during the frame period, and the arrangement of the multiple subfield periods in which the on voltage is to be applied and the arrangement of the multiple subfield periods in which the off voltage is to be applied, are determined in accordance with the tone to be displayed, and the absolute value of the positive-polarity voltage and the absolute value of the negative-polarity voltage are different.

### BRIEF DESCRIPTION OF THE DRAWINGS

The invention will be described with reference to the accompanying drawings, wherein like numbers reference like elements.

FIG. 1 is a block diagram illustrating the main configuration of a projector according to an embodiment of the invention.

FIG. 2 is a block diagram illustrating the main configuration of an image formation unit in a projector according to an embodiment of the invention.

FIG. 3 is a perspective view illustrating an image formation panel in a projector according to an embodiment of the invention.

FIG. 4 is a cross-section viewed along the IV-IV line shown in FIG. 3.

FIG. 5 is a block diagram illustrating a liquid crystal panel driving circuit and a liquid crystal panel according to an embodiment of the invention.

FIG. 6 is a plan view illustrating part of multiple pixels in an image forming panel according to an embodiment of the invention.

FIG. 7 is a cross-section of a liquid crystal panel according to an embodiment of the invention, viewed along the VII-VII line illustrated in FIG. 6.

FIG. 8 is an enlarged view of a TFT element shown in FIG. 7.

FIG. 9 is a plan view illustrating the arrangement of a semiconductor layer, signal lines, and scanning lines according to an embodiment of the invention.

FIG. 10 is a plan view illustrating the arrangement of the pixel electrodes according to an embodiment of the invention.

FIG. 11 is a circuit diagram illustrating a scanning line driving circuit according to an embodiment of the invention.

FIG. 12 is a timing chart illustrating subfield periods according to an embodiment of the invention.

FIG. 13 is a timing chart illustrating selection signals according to an embodiment of the invention.

FIG. 14 is a timing chart illustrating selection signals according to an embodiment of the invention.

FIG. 15 is a block diagram illustrating a signal line driving circuit according to an embodiment of the invention.

FIG. 16 is a diagram illustrating an image data-subfield driving data conversion LUT according to an embodiment of the invention.

FIGS. 17A-17D are timing charts illustrating a positive-polarity period and a negative-polarity period according to an embodiment of the invention.

FIGS. 18A-18F illustrate examples of driving voltages and liquid crystal responses according to an embodiment of the invention.

FIG. 19 is a perspective view of an electronic device in which an electro-optical apparatus according to an embodiment of the invention has been applied.

### DESCRIPTION OF EXEMPLARY EMBODIMENTS

An embodiment of the invention will be described with reference to the drawings, using a projector, which is an electronic device, as an example.

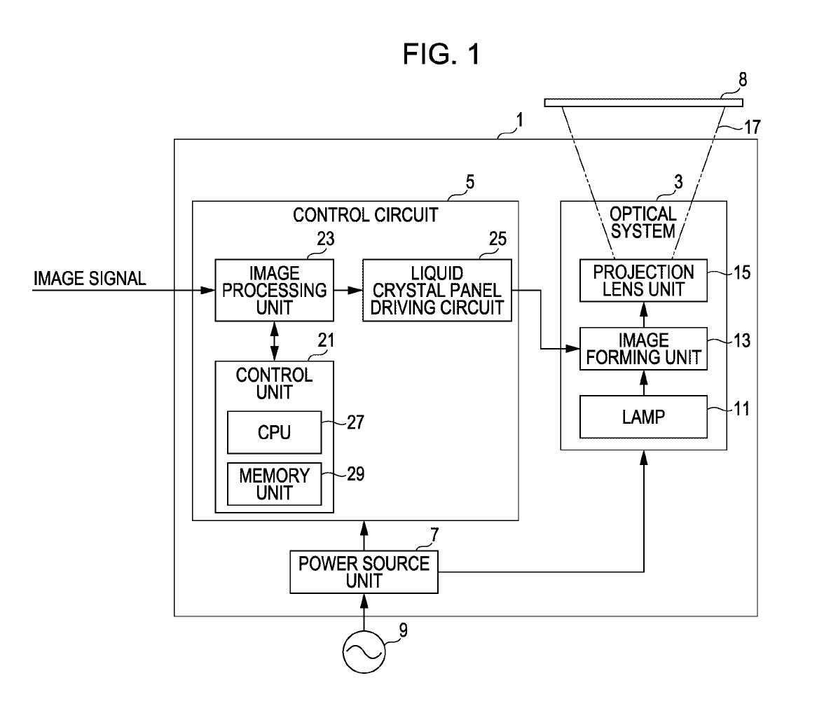

A projector 1 according to this embodiment includes an optical system 3, a control circuit 5, and a power source unit 7, as illustrated in FIG. 1, which is a block diagram illustrating the main configuration of the projector 1. The projector 1 is capable of projecting an image based on an image signal inputted from an external device (not shown) onto a screen 8 or the like via the optical system 3.

The optical system 3 forms an image based on an image signal, and projects the formed image onto the screen 8 or the like. The control circuit 5 controls the driving of the optical system 3 based on the image signal.

Note that in the projector 1, electrical power inputted from an external power source 9 is converted into DC electrical power by the power source unit 7. The DC electrical power from the power source unit 7 is supplied to the optical system 3, the control circuit 5, and the like.

The optical system 3 includes a lamp 11, an image forming unit 13, and a projection lens unit 15. The lamp 11 emits projection light 17, which passes through the image forming unit 13, the projection lens unit 15, and so on, and is emitted in the direction of the screen 8. A high-pressure mercury lamp, a metal halide lamp, or the like can be employed as the lamp 11.

The image forming unit 13 includes a liquid crystal panel, which will be described later, and so on. The image forming unit 13 forms an image on the liquid crystal panel based on image data or the like inputted from the control circuit 5. The image forming unit 13 is irradiated with light from the lamp 11. Accordingly, an image formed in the image forming unit 13 is projected onto the projection lens unit 15 by the light from the lamp 11.

Light from the lamp 11 enters into the projection lens unit 15 after passing through the image forming unit 13. The projection lens unit 15 causes the light that has entered therein to refract in a spread-out direction, and the resulting light is emitted as the projection light 17. Accordingly, an image formed in the image forming unit 13 can be projected onto the screen 8 in an enlarged state.

The control circuit 5 includes a control unit 21, an image processing unit 23, and a liquid crystal panel driving circuit 25.

The control unit 21 is configured of, for example, a microcomputer, and includes a CPU (Central Processing Unit) 27 and a memory unit 29.

The CPU 27 performs overall control of the operations of the projector 1 in accordance with a control program stored in the memory unit 29. The memory unit 29 includes a flash memory such as a ROM (Read-Only Memory), a RAM (Random Access Memory), and the like. The control program executed by the CPU 27 and so on is stored in the ROM. The RAM temporarily expands the control program executed by the CPU 27, temporarily stores various setting values, and so on.

An image signal is inputted into the image processing unit 23. The image processing unit 23 performs various processes on the image signal based on instructions from the control unit 21. Furthermore, the image processing unit 23 converts the image signal into image data. The image data obtained by converting the image signal is outputted to the liquid crystal panel driving circuit 25.

Note that processes for making various types of image quality adjustments, combining menus, messages, and so on into an OSD (On-Screen Display) image, and so on can be given as examples of processes performed by the image processing unit 23 on the image signal. Furthermore, resolution conversion, luminance adjustment, contrast adjustment, sharpness adjustment, and so on can be given as examples of the various types of image quality adjustments.

The liquid crystal panel driving circuit 25 controls the driving of the image forming unit 13 in accordance with inputted image data.

Here, the configuration of the image forming unit 13 will be described in detail.

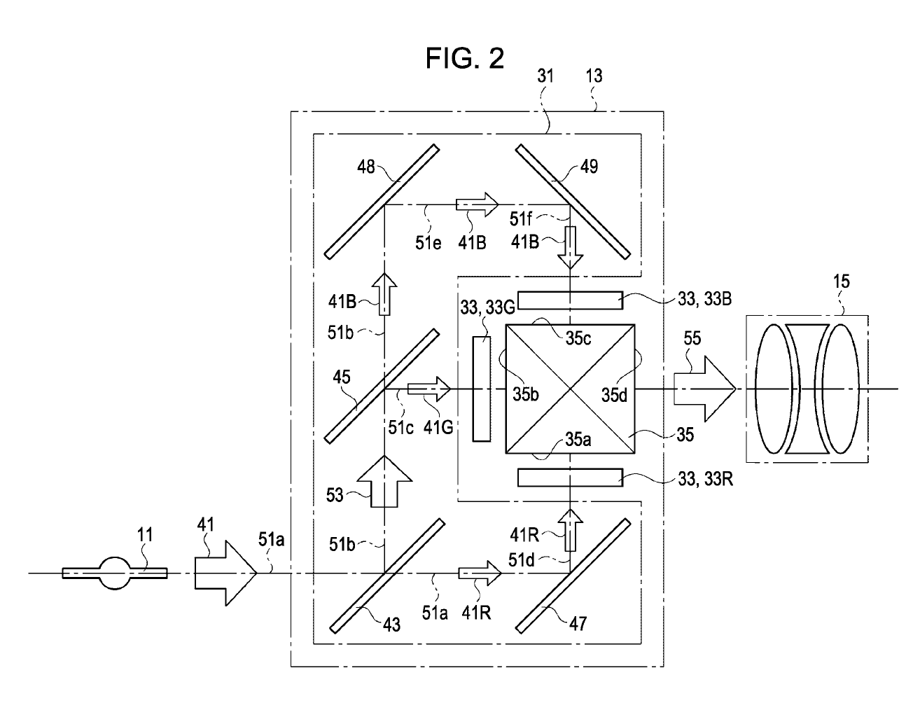

The image forming unit 13 includes a spectroscopic unit 31, image forming panels 33, and a cross dichroic prism 35, as shown in FIG. 2, which is a diagram illustrating the main configuration of the image forming unit 13.

Light 41 from the lamp 11 enters into the spectroscopic unit 31. The spectroscopic unit 31 splits the light 41 into red (R) color light 41R, green (G) color light 41G, and blue (B) color light 41B.

Here, the R color is not limited to a pure red hue, and also includes oranges and the like as well. The G color, meanwhile, is not limited to a pure green hue, and also includes blue-green, yellow-green, and so on. The B color is also not limited to a pure blue hue, and also includes blue-purple, blue-green, and so on. Taking this from a different perspective, the light 41R expressing the R color can be defined as light that has an optical wavelength peak in a range of greater than or equal to 570 nm in the visible light range. The light 41G expressing the G color can be defined as light that has an optical wavelength peak in the range of 500 nm to 565 nm. Finally, the light 41B expressing the B color can be defined as light that has an optical wavelength peak in the range of 415 nm to 495 nm.

The spectroscopic unit 31 includes a dichroic mirror 43, a dichroic mirror 45, a reflection mirror 47, a reflection mirror 48, and a reflection mirror 49. The light 41 enters the spectroscopic unit 31 along an optical axis 51a.

The dichroic mirror 43 is provided in a position that intersects with the optical axis 51a. The dichroic mirror 43 is slanted relative to the direction of the optical axis 51a. Of the light 41, the dichroic mirror 43 is capable of allowing the R light 41R to pass while reflecting the G light 41G and the B light 41B.

Accordingly, the R light 41R can be separated from the light 41 by the dichroic mirror 43. Meanwhile, light 53 in which the G light 41G and the B light 41B are mixed can be separated from the light 41 by the dichroic mirror 43.

The light 41R that has passed through the dichroic mirror 43 is led to the reflection mirror 47 along the optical axis 51a.

Meanwhile, the light 53 reflected by the dichroic mirror 43 is changed from the optical axis 51a to an optical axis 51b, and is then led to the dichroic mirror 45.

The dichroic mirror 45 is provided in a position that intersects with the optical axis 51b. The dichroic mirror 45 is slanted relative to the direction of the optical axis 51b. Of the light 53, the dichroic mirror 45 is capable of allowing the B light 41B to pass while reflecting the G light 41G. Accordingly, the G light 41G and B light 41B can be separated from the light 53 by the dichroic mirror 45.

The light 41B that has passed through the dichroic mirror 45 is led to the reflection mirror 48 along the optical axis 51b.

Meanwhile, the light 41G reflected by the dichroic mirror 45 is changed from the optical axis 51b to an optical axis 51c.

The reflection mirror 47 is provided in a position that intersects with the optical axis 51a of the light 41R. The reflection mirror 47 is slanted relative to the direction of the optical axis 51a. The light 41R is reflected by the reflection mirror 47, and thus is changed from the optical axis 51a to an optical axis 51d.

The reflection mirror 48 is provided in a position that intersects with the optical axis 51b of the light 41B. The reflection mirror 48 is slanted relative to the direction of the optical axis 51b. The light 41B is changed from the optical axis 51b to an optical axis 51e by the reflection mirror 48, and is then led to the reflection mirror 49.

The reflection mirror 49 is provided in a position that intersects with the optical axis 51e of the light 41B. The reflection mirror 49 is slanted relative to the direction of the optical axis 51e. The light 41B is reflected by the reflection mirror 49, and thus changes from the optical axis 51e to an optical axis 51f.

The cross dichroic prism 35 is provided in a position where the optical axis 51c, the optical axis 51d, and the optical axis 51f intersect. The cross dichroic prism 35 has a surface 35a, a surface 35b, a surface 35c, and a surface 35d.

The surface 35a faces toward the reflection mirror 47. The surface 35b faces toward the dichroic mirror 45. The surface 35c faces toward the reflection mirror 49.

An image forming panel 33 is provided for each of the light 41R, the light 41G, and the light 41B. In other words, the projector 1 includes an image forming panel 33 corresponding to the light 41R, an image forming panel 33 corresponding to the light 41G, and an image forming panel 33 corresponding to the light 41B. Note that hereinafter, when the image forming panels 33 are to be identified with respect to the light 41R, the light 41G, and the light 41B, the image forming panels 33 will be referred to as an image forming panel 33R, an image forming panel 33G, and an image forming panel 33B.

The image forming panel 33R, the image forming panel 33G, and the image forming panel 33B can employ image forming panels 33 that have the same specifications.

The image forming panel 33R is provided between the surface 35a and the reflection mirror 47 in a position that intersects with the optical axis 51d. The image forming panel 33R opposes the surface 35a. The image forming panel 33G is provided between the surface 35b and the dichroic mirror 45 in a position that intersects with the optical axis 51c. The image forming panel 33G opposes the surface 35b.

The image forming panel 33B is provided between the surface 35c and the reflection mirror 49 in a position that intersects with the optical axis 51f. The image forming panel 33B opposes the surface 35c.

Here, the image forming panels 33 include transmissive type liquid crystal panels as light bulbs.

Each liquid crystal panel includes multiple pixels, described later, and liquid crystals whose driving is controlled on a pixel-by-pixel basis. Each liquid crystal panel is capable of changing the diffusion state of the light that enters the multiple pixels, on a pixel-by-pixel basis. The liquid crystal panels will be described in detail later.

With the image forming panels 33, an image can be formed using the light that has passed through the image forming panels 33 by changing the diffusion state of the light that has entered the multiple pixels of the liquid crystal panel on a pixel-by-pixel basis.

The light that has passed through the image forming panels 33 is led into the cross dichroic prism 35. The light 41R that has passed through the image forming panel 33R enters the cross dichroic prism 35 from the surface 35a.

The light 41G that has passed through the image forming panel 33G enters the cross dichroic prism 35 from the surface 35b.

The light 41B that has passed through the image forming panel 33B enters the cross dichroic prism 35 from the surface 35c.

Accordingly, an R image is projected on the surface 35a, a G image is projected on the surface 35b, and a B image is projected on the surface 35c.

The light 41R, the light 41G, and the light 41B that have entered the cross dichroic prism 35 are combined by the cross dichroic prism 35. In other words, the R image, the G image, and the B image can be combined by the cross dichroic prism 35.

The light 41R, the light 41G, and the light 41B combined by the cross dichroic prism 35 are projected from the surface 35d of the cross dichroic prism 35 as image light 55.

The image light 55 emitted from the surface 35d is led to the projection lens unit 15, and then enters into the projection lens unit 15. The image light 55 that has entered into the projection lens unit 15 is projected onto the screen 8 or the like as the projection light 17 (FIG. 1).

Here, the configuration of the image forming panels 33 will be described in detail.

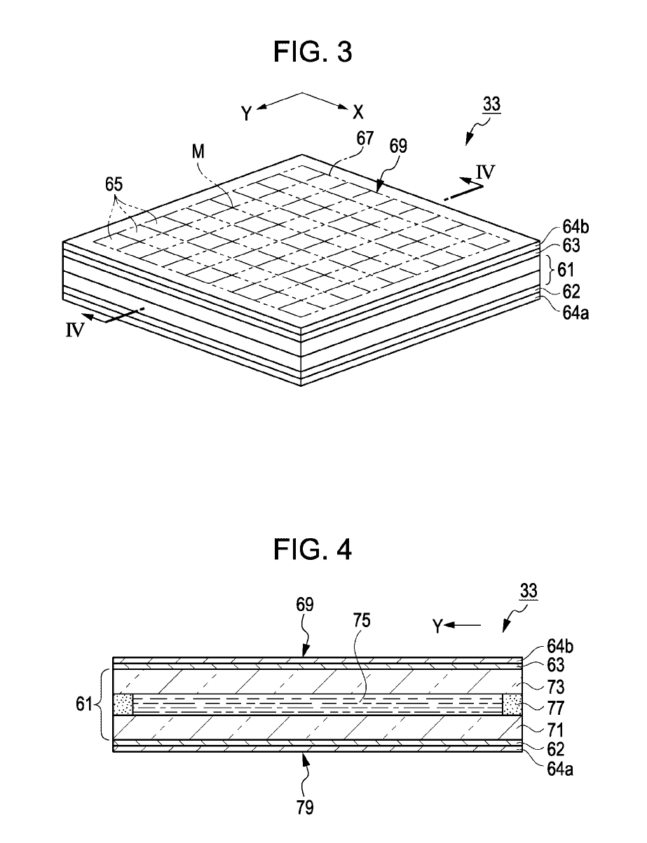

As shown in FIG. 3, each image forming panel 33 includes a liquid crystal panel 61, a wave plate 62, a wave plate 63, a polarizer 64a, and a polarizer 64b.

Here, multiple pixels 65 are configured in the image forming panel 33. The multiple pixels 65 are disposed within a region 67 in the X and Y directions in FIG. 3, thus configuring a matrix M in which the X direction is taken as the row direction and the Y direction is taken as the column direction.

In FIG. 3, the size of the pixels 65 has been exaggerated and the number of the pixels 65 has been reduced in order to make the configuration more easily understandable.

Note that the X direction is also a direction in which scanning lines, described later, extend. Meanwhile, the Y direction is also a direction in which signal lines, described later, extend.

With the projector 1, each image forming panel 33 has a surface 69 on the side of the polarizer 64b facing toward the cross dichroic prism 35 shown in FIG. 2. With the image forming panel 33, an image is formed (displayed) on the side of the surface 69. Accordingly, the surface 69 will be described as a display surface 69 hereinafter.

The region 67 corresponds to a region in which an image is formed (displayed). Accordingly, the region 67 will be described as a display region 67 hereinafter.

The liquid crystal panel 61 includes an element substrate 71, an opposing substrate 73, a liquid crystal 75, and a sealant 77, as shown in FIG. 4, which is a cross-sectional view along the IV-IV line shown in FIG. 3.

Switching elements and the like, described later, are provided in the element substrate 71 on the display surface 69 side, or in other words, on the liquid crystal 75 side, corresponding to each of the multiple pixels 65.

The opposing substrate 73 is disposed opposing the element substrate 71 closer to the display surface 69 side than the element substrate 71, and is provided in a state in which a space is present between the opposing substrate 73 and the element substrate 71. An opposing electrode and the like, described later, are provided in the opposing substrate 73 on the side of a surface 79, or in other words, on the liquid crystal 75 side. Note that the surface 79 corresponds to the bottom surface of the image forming panel 33, on the side opposite the display surface 69. Accordingly, the surface 79 will be described as a bottom surface 79 hereinafter.

The liquid crystal 75 is sandwiched between the element substrate 71 and the opposing substrate 73, and is confined between the element substrate 71 and the opposing substrate 73 by the sealant 77, which surrounds the display region 67 inward to the peripheral edge of the liquid crystal panel 61. In this embodiment, the VA (Vertical Alignment) method is employed as the alignment method of the liquid crystal 75.

The wave plate 62 is provided closer to the bottom surface 79 than the element substrate 71, or in other words, on the side opposite to the liquid crystal 75 side.

The wave plate 63 is provided closer to the display surface 69 than the opposing substrate 73, or in other words, on the side opposite the liquid crystal 75 side. With the image forming panel 33, the wave plate 62 and the wave plate 63 each apply a phase difference to entering light, thereby enabling the diffusion state of the light entering into the image forming panel and the light emitted from the image forming panel to be optimized.

The polarizer 64a is provided on the bottom surface 79 side of the element substrate 71. The polarizer 64b, meanwhile, is provided on the display surface 69 side of the wave plate 63. The polarizer 64a and the polarizer 64b are each capable of allowing linearly-polarized light having a polarization axis that follows the transmission axis to pass therethrough.

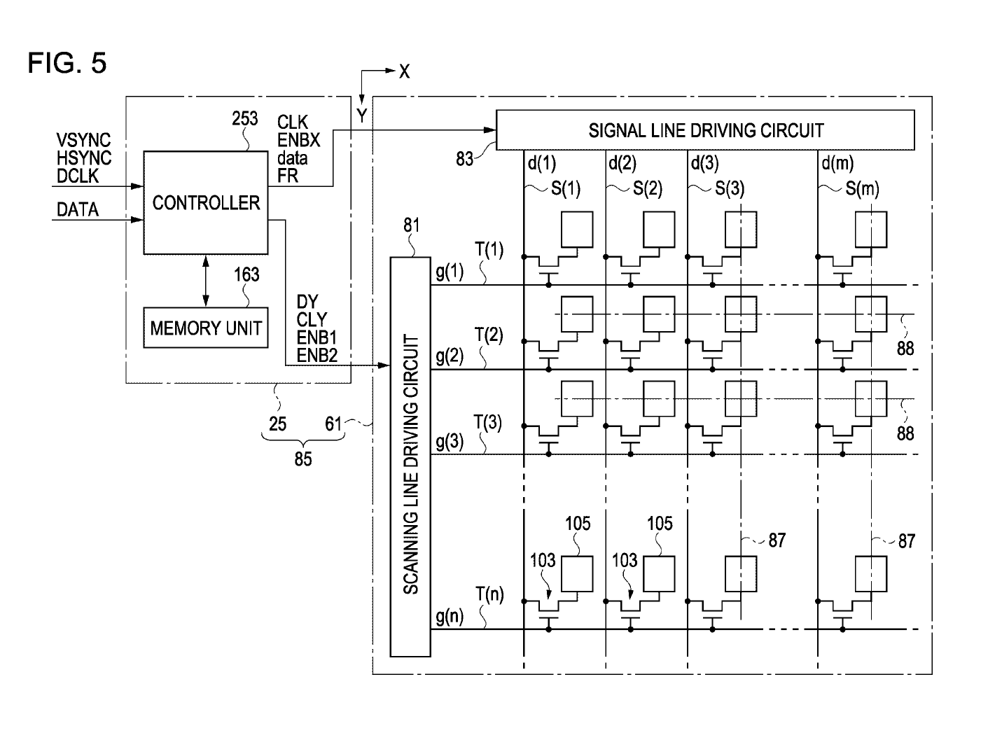

Meanwhile, the liquid crystal panel 61 includes a scanning line driving circuit 81 and a signal line driving circuit 83, as illustrated in FIG. 5, which is a block diagram illustrating the liquid crystal panel driving circuit 25 and the liquid crystal panel 61. The liquid crystal panel driving circuit 25 and the liquid crystal panel 61 are each constituent elements of a liquid crystal apparatus 85, which is an example of an electro-optical apparatus.

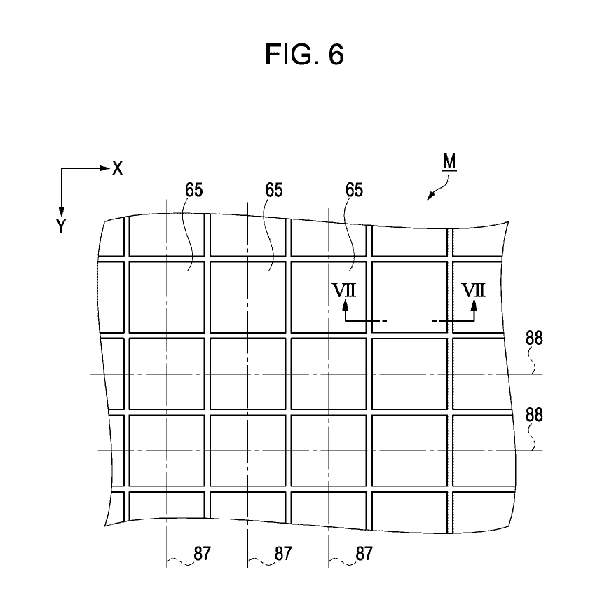

With the matrix M, the multiple pixels 65 arranged in the Y direction configure a single pixel column 87, as shown in FIG. 6. Meanwhile, the multiple pixels 65 arranged in the X direction configure a single pixel row 88.

Here, the configurations of the element substrate 71 and the opposing substrate 73 of the liquid crystal panel 61 will be described in detail.

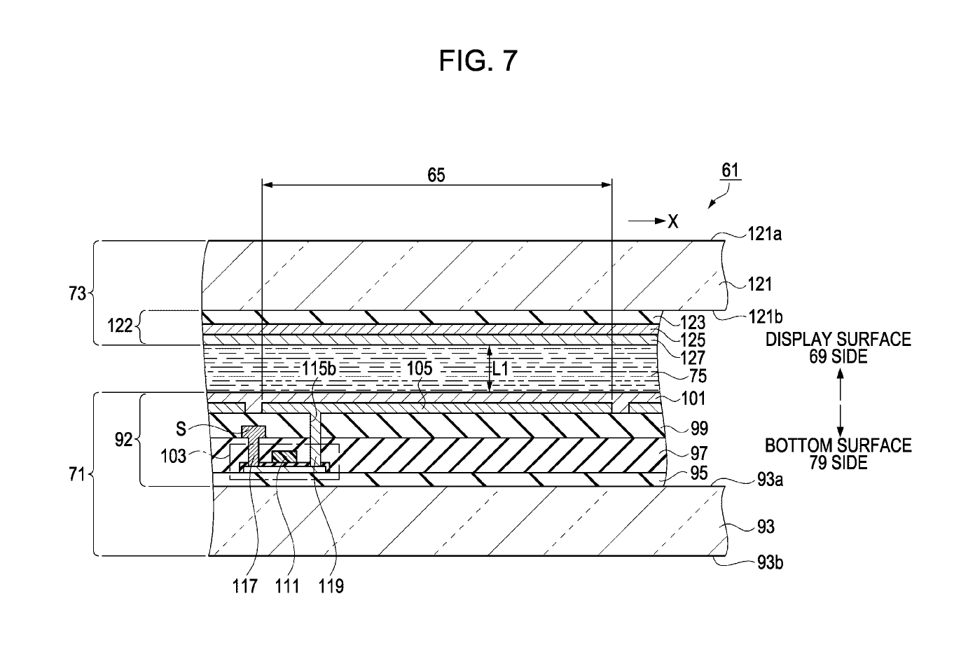

The element substrate 71 includes a first substrate 93 and an element layer 92, as shown in FIG. 7, which is a cross-sectional view along the VII-VII line shown in FIG. 6.

The first substrate 93 is configured of a light-transmissive material such as glass or silica, and includes a first surface 93a facing toward the display surface 69 side and a second surface 93b facing toward the bottom surface 79 side.

The element layer 92 is provided on the first surface 93a of the first substrate 93. The element layer 92 includes an insulating film 95, an insulating film 97, an insulating film 99, and an alignment layer 101. The element layer 92 also includes a TFT (Thin Film Transistor) element 103, which is an example of a switching element, a pixel electrode 105, and a capacitance element (not shown), for each of the pixels 65, as shown in FIG. 5.

The insulating film 95 is provided on the first surface 93a of the first substrate 93, as shown in FIG. 7. The insulating film 97 is provided on the display surface 69 side of the insulating film 95. The insulating film 99 is provided on the display surface 69 side of the insulating film 97. The pixel electrode 105 is provided on the display surface 69 side of the insulating film 99. The alignment layer 101 is provided on the display surface 69 side of the pixel electrode 105. Note that an inorganic material such as silicon oxide, silicon nitride, or the like can be employed as the material for the insulating film 95. In this embodiment, silicon oxide is employed as the material of the insulating film 95.

A TFT element 103 and a pixel electrode 105 are each provided in correspondence with each pixel 65.

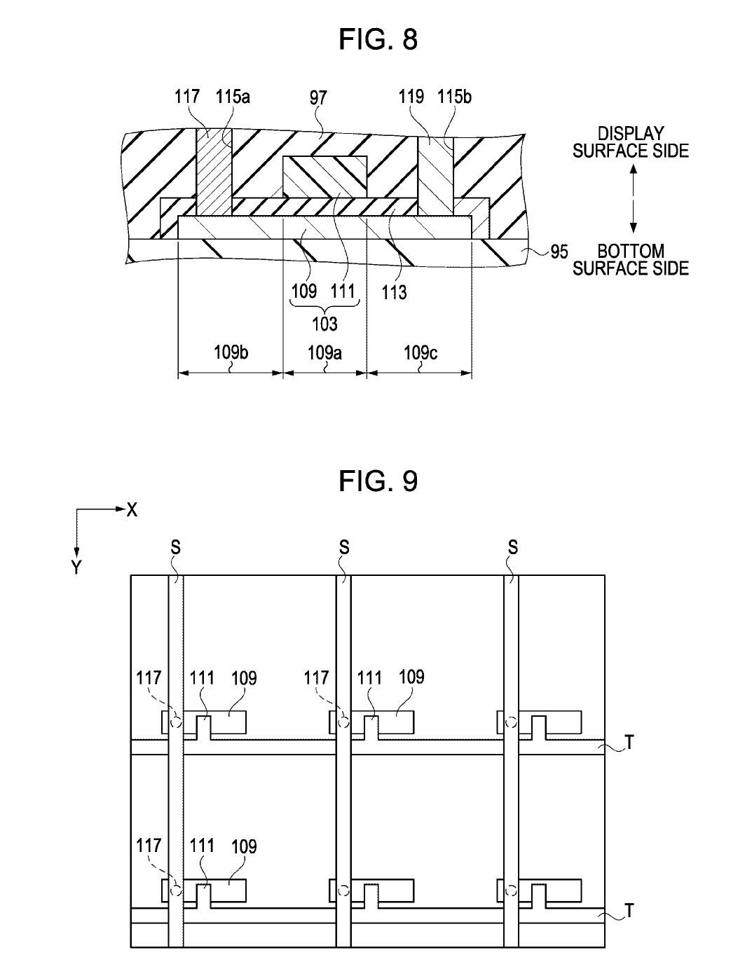

The TFT element 103 includes a semiconductor layer 109 and a gate electrode 111, as illustrated in FIG. 8, which is an enlarged view. The semiconductor layer 109 is provided on the display surface 69 side of the insulating film 95. The semiconductor layer 109 is covered by a gate insulating film 113 from the display surface 69 side.

Single crystal silicon, polycrystal silicon, non-crystalline silicon, and so on can be employed as the semiconductor layer 109. In this embodiment, polycrystal silicon is employed as the material of the insulating film 109.

Note that an inorganic material such as silicon oxide, silicon nitride, or the like can be employed as the material for the gate insulating film 113. In this embodiment, silicon oxide is employed as the material of the gate insulating film 113.

The gate electrode 111 is provided so as to oppose the semiconductor layer 109, sandwiching the gate insulating film 113 therewith.

Ion-implanted polycrystal silicon or the like can be employed as the material of the gate electrode 111. It is also possible to use a metal such as molybdenum, tungsten, tantalum, or chromium, an alloy containing those metals, or the like as the material of the gate electrode 111. Molybdenum silicide, tungsten silicide, and so on can be given as examples of alloys containing molybdenum or tungsten.

In this embodiment, what is known as a polysilicon gate, in which polycrystal silicon has been implanted with ions, is employed as the gate electrode 111.

In this embodiment, the semiconductor layer 109 includes a channel region 109a, a source region 109b, and a drain region 109c.

The channel region 109a overlaps with the gate electrode 111 when viewed from above. The source region 109b and the drain region 109c are each provided on the outer side of the channel region 109a when viewed from above. The channel region 109a is provided between the source region 109b and the drain region 109c.

Note that a configuration in which an LDD (Lightly Doped Drain) region is provided between the channel region 109a and the source region 109b, between the channel region 109a and the drain region 109c, and so on can also be employed as the semiconductor layer 109.

The TFT element 103 configured as described thus far is covered by the insulating film 97 from the display surface 69 side. An inorganic material such as silicon oxide, silicon nitride, or the like can be employed as the material for the insulating film 97. In this embodiment, silicon oxide is employed as the material of the insulating film 97.

The insulating film 97 and the gate insulating film 113 are provided with a contact hole 115a and a contact hole 115b.

The contact hole 115a communicates with the source region 109b. The contact hole 115b communicates with the drain region 109c. A source electrode 117 is provided within the contact hole 115a. A drain electrode 119 is provided within the contact hole 115b.

As shown in FIG. 7, a signal line S is provided in the insulating film 97 on the display surface 69 side. The signal line S is provided in a position overlapping with the source electrode 117 when viewed from above. The signal line S and the source electrode 117 are electrically connected to each other. The signal line S is also electrically connected to the source region 109b of the semiconductor layer 109 (FIG. 8) via the source electrode 117. As shown in FIG. 7, the signal line S is covered by the insulating film 99 from the display surface 69 side. An inorganic material such as silicon oxide, silicon nitride, or the like can be employed as the material for the insulating film 99. In this embodiment, silicon oxide is employed as the material of the insulating film 99.

Here, the contact hole 115b shown in FIG. 8 communicates with the display surface 69 side of the insulating film 99. As shown in FIG. 7, the drain electrode 119 communicates with the display surface 69 side of the insulating film 99. The pixel electrode 105 and the drain electrode 119 are electrically connected to each other. The pixel electrode 105 is also electrically connected to the drain region 109c of the semiconductor layer 109 (FIG. 8) via the drain electrode 119.

A light-transmissive material such as, for example, ITO (Indium Tin Oxide), Indium Zinc Oxide, or the like can be employed as the pixel electrode 105. In this embodiment, ITO is employed as the material of the pixel electrode 105.

As shown in FIG. 7, the pixel electrode 105 is covered by the alignment layer 101 from the display surface 69 side.

A light-transmissive material such as, for example, polyimide, can be employed as the material of the alignment layer 101. In this embodiment, polyimide is employed as the material of the alignment layer 101. Note that an alignment process has been carried out on the alignment layer 101 on the display surface 69 side.

The opposing substrate 73 includes a second substrate 121 and an opposing layer 122. The second substrate 121 is configured of a light-transmissive material such as glass or silica, and includes an outward-facing surface 121a facing toward the display surface 69 side and an opposing surface 121b facing toward the bottom surface 79 side. The opposing layer 122 is provided on the opposing surface 121b of the second substrate 121. The opposing layer 122 includes an insulating film 123, an opposing electrode 125, and an alignment layer 127.

The insulating film 123 is provided on the opposing surface 121b of the second substrate 121. An inorganic material such as silicon oxide, silicon nitride, or the like can be employed as the material for the insulating film 123. In this embodiment, silicon oxide is employed as the material of the insulating film 123.

The opposing electrode 125 is provided on the bottom surface 79 side of the insulating film 123. A light-transmissive material such as, for example, ITO, Indium Zinc Oxide, or the like can be employed as the material of the opposing electrode 125. In this embodiment, ITO is employed as the material of the opposing electrode 125. The opposing electrode 125 is provided in a serial state across the multiple pixels 65 that configure the matrix M (FIG. 3). The opposing electrode 125 functions commonly with respect to the multiple pixels 65 that configure the matrix M.

Note that in this embodiment, the region of a pixel 65 can be defined as the region in which a single pixel electrode 105 overlaps with the opposing electrode 125, as shown in FIG. 7.

The alignment layer 127 is provided on the bottom surface 79 side of the opposing electrode 125. The opposing electrode 125 is covered by the alignment layer 127 on the bottom surface 79 side. A light-transmissive material such as, for example, polyimide, can be employed as the material of the alignment layer 127. In this embodiment, polyimide is employed as the material of the alignment layer 127. Note that an alignment process has been carried out on the alignment layer 127 on the bottom surface 79 side.

Here, multiple source electrodes 117 arranged in the Y direction are electrically connected to each other at the pixel column 87 level (FIG. 5) via a signal line S, as shown in FIG. 9.

Meanwhile, multiple gate electrodes 111 arranged in the X direction are electrically connected to each other at the pixel row 88 level (FIG. 5) via a scanning line T, as shown in FIG. 9.

Multiple signal lines S extend in the Y direction, and are arranged in the X direction. A gap is provided between signal lines S that are adjacent in the X direction.

Multiple scanning lines T extend in the X direction, and are arranged in the Y direction. A gap is provided between scanning lines T that are adjacent in the Y direction.

In this embodiment, although not shown, capacitance lines are provided extending along the X direction. The capacitance lines are provided in correspondence with the scanning lines T, or in other words, for each pixel row 88 (FIG. 5). In this embodiment, the capacitance lines are provided on the display surface 69 side of the insulating film 95 shown in FIG. 7, and are covered by the insulating film 97 from the display surface 69 side. A metal such as molybdenum, tungsten, or chromium, an alloy containing those metals, or the like can be employed as the material of the capacitance lines. Note that the capacitance lines and the gate electrodes 111 (scanning lines T) are arranged in a state in which there is a gap therebetween in the Y direction shown in FIG. 9.

The pixels 65 are set in correspondence to each intersection between the multiple signal lines S and the multiple scanning lines T.

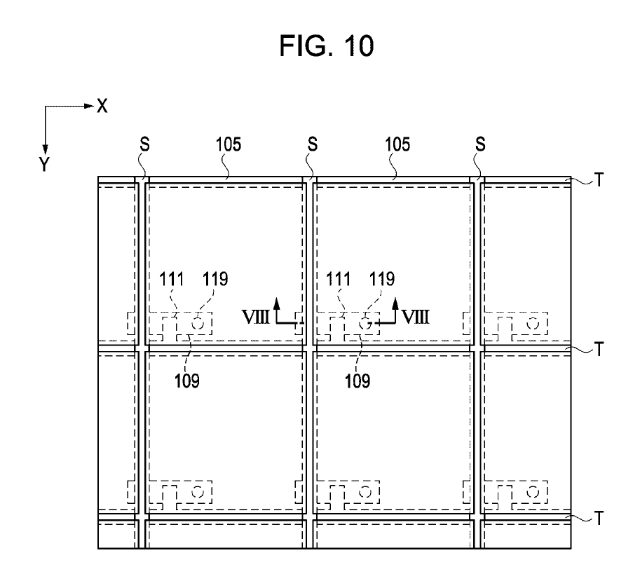

As shown in FIG. 10, the pixel electrodes 105 overlap with the regions that are boxed in by adjacent signal lines S and adjacent scanning lines T. Note that in this embodiment, the edge portions of the pixel electrodes 105 overlap the signal lines S and the scanning lines T. Furthermore, the pixel electrodes 105 overlap the capacitance lines.

Accordingly, with the liquid crystal panel 61, the capacitance element illustrated in FIG. 5 is formed between the capacitance lines and the pixel electrodes 105.

Note that the cross-section of the TFT element 103 shown in FIG. 7 corresponds to a cross-sectional view along the VIII-VIII line shown in FIG. 10.

In this embodiment, the liquid crystal panel 61 includes, as shown in FIG. 5, n scanning lines T (where n is an integer greater than or equal to 1) and m signal lines S (where m is an integer greater than or equal to 1). Note that hereinafter, when differentiating between individual scanning lines T, the denotation “scanning line T(i)” will be used. i is an integer no less than 1 and no more than n. Similarly, when differentiating between individual signal lines S, the denotation “signal line S(j)” will be used. j is an integer no less than 1 and no more than m.

The liquid crystal 75 present between the element substrate 71 and the opposing substrate 73 is, as shown in FIG. 7, present between the alignment layer 101 and the alignment layer 127.

In this embodiment, the sealant 77 shown in FIG. 4 is sandwiched between the first surface 93a of the first substrate 93 and the opposing surface 121b of the second substrate 121 shown in FIG. 7. In other words, with the liquid crystal panel 61, the liquid crystal 75 is held by the first substrate 93 and the second substrate 121. Note that the sealant 77 may be provided between the alignment layer 101 and the alignment layer 127. In this case, the liquid crystal 75 can be seen as being held by the element substrate 71 and the opposing substrate 73.

As shown in FIG. 7, the liquid crystal 75 is set so as to have a thickness L1. The liquid crystal 75 is capable of modulating light that has entered therein. In this embodiment, the liquid crystal 75 applies a phase difference to light that has entered therein. This can be realized by setting the retardation (the product of the birefringence and the thickness L1) of the liquid crystal 75. In this embodiment, a retardation that applies a ½ wavelength phase difference to the light that has entered is set.

With the liquid crystal panel 61, when a voltage is applied between the pixel electrode 105 and the opposing electrode 125, an electrical field is produced between the pixel electrode 105 and the opposing electrode 125. Furthermore, with the liquid crystal panel 61, when the TFT element 103 changes from an off state to an on state, an electrical field is produced between the pixel electrode 105 and the opposing electrode 125. The alignment state of the liquid crystal 75 can be changed on a pixel 65-by-pixel 65 basis using this electrical field.

In this embodiment, when the electrical field acts on the liquid crystal 75, the liquid crystal 75 enters an on state. Meanwhile, when the electrical field acting on the liquid crystal 75 is released, the liquid crystal 75 enters an off state.

With the projector 1, the display is controlled by changing the alignment state of the liquid crystal 75 in the liquid crystal panels 61 on a pixel 65-by-pixel 65 basis in a state in which the image forming unit 13 shown in FIG. 2 is irradiated with the light 41. The orentation state of the liquid crystal 75 can be changed by switching the TFT element 103 between the off state and the on state.

Alignment processes have been carried out on the alignment layer 101 and the alignment layer 127, respectively, shown in FIG. 7. The initial alignment state of the liquid crystal 75 is defined by the alignment layer 101 and the alignment layer 127 on which the alignment processes have been carried out.

With the image forming panel 33, the diffusion state of light passing through the liquid crystal 75 is controlled by switching the liquid crystal 75 between the on state and the off state, thereby controlling the formation of images.

In this embodiment, what is called the “normally black” display mode (where a black display is the default state) is employed, where the light emission from the image forming panel 33 is blocked when the liquid crystal 75 is in the off state. However, the display mode is not limited to the normally black mode, and what is called the “normally white” mode (where a white display is the default state) can be employed as well.

In the normally black mode, when the transmissibility in the darkest state is taken as a relative transmissibility of 0% and the transmissibility in the brightest state is taken as a relative transmissibility of 100%, a voltage applied to the liquid crystal 75 that results in a relative transmissibility of 10% is called an “optical threshold voltage”, and a voltage applied to the liquid crystal 75 that results in a relative transmissibility of 90% is called an “optical saturation voltage”. Normally, the optical threshold voltage corresponds to an off voltage, whereas the optical saturation voltage corresponds to an on voltage. With a voltage modulation technique (analog driving), settings are made so that a voltage that is less than the optical saturation voltage is applied to the liquid crystal 75 when the liquid crystal 75 is to display a halftone (gray color). For this reason, the transmissibility of the liquid crystal 75 takes on a value that is essentially proportional to the voltage applied to the liquid crystal 75.

With the normally white mode, a voltage applied to the liquid crystal 75 that results in a relative transmissibility of 90% is called the optical threshold voltage, whereas a voltage applied to the liquid crystal 75 that results in a relative transmissibility of 10% is called the optical saturation voltage. In this specification, for the sake of simplicity, the optical threshold voltage corresponds to an off voltage and the optical saturation voltage corresponds to an on voltage in the case of the normally white mode as well.

Here, a driving method for the liquid crystal apparatus 85 illustrated in FIG. 5 will be described.

The liquid crystal panel driving circuit 25 includes, as shown in FIG. 5, a controller 253 and a memory unit 163.

A vertical synchronization signal VSYNC, a horizontal synchronization signal HSYNC, a clock signal DCLK, and image data DATA are supplied to the controller 253 via the image processing unit 23 shown in FIG. 1.

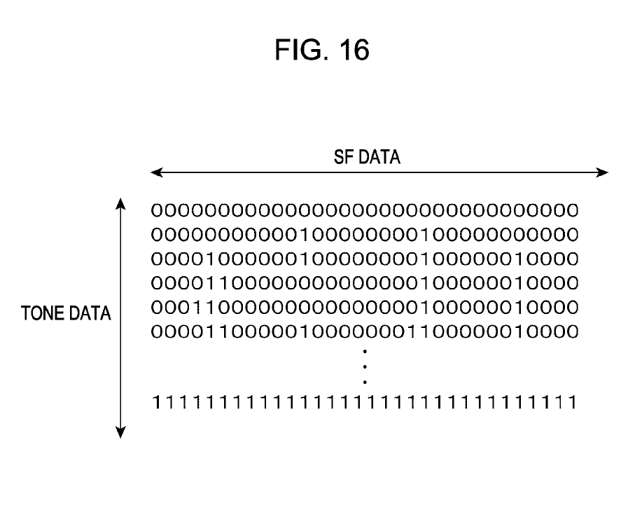

A single frame's worth of image data DATA is converted into subfield driving data SFDATA, and is then temporarily stored in the memory unit 163. A lookup table (LUT) is used in the conversion to subfield driving data SFDATA. FIG. 16 illustrates an example of an LUT, and corresponding subfield driving data SFDATA is called based on the tonal values of the image data. The controller 253 reads out, from the single frame's worth of subfield driving data SFDATA stored in the memory unit 163, subfield driving data sfdata at the pixel row 88 level for a specific subfield. The controller 253 outputs the read-out subfield driving data sfdata to the signal line driving circuit 83 as serial data. A clock signal CLX, an enable signal ENBX, and a polarity inversion signal FR are also inputted into the signal line driving circuit 83 from the controller 253.

Here, in this embodiment, subfield driving, in which at least part of a single frame period is divided into multiple subfield periods, is employed. With subfield driving, the on state and off state of the liquid crystal 75 can be controlled at the subfield period level.

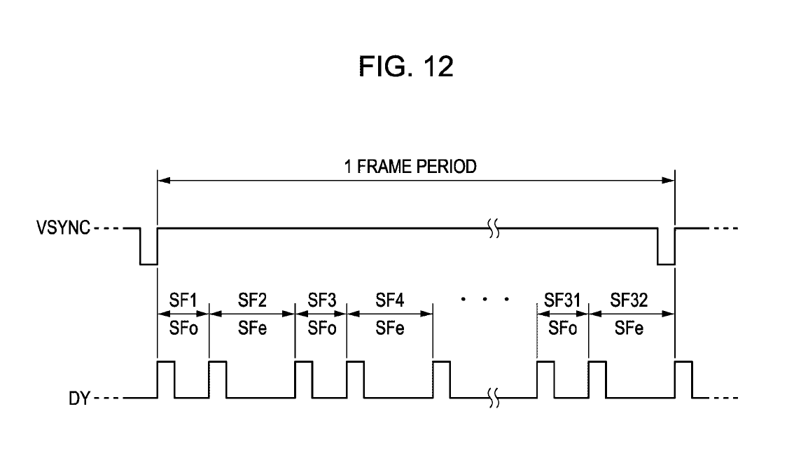

In this embodiment, a single frame period is, as shown in FIG. 12, divided into 32 subfield periods SF1 to SF32.

Note that hereinafter, the denotations “subfield period SF1 to subfield period SF32” and “subfield period SF” will be used in tandem with each other.

The vertical synchronization signal VSYNC is a signal that defines the start of a frame period. A start pulse DY is a signal that defines the start of a subfield period SF, and is generated by the controller 253 (FIG. 5) using the vertical synchronization signal VSYNC as a reference.

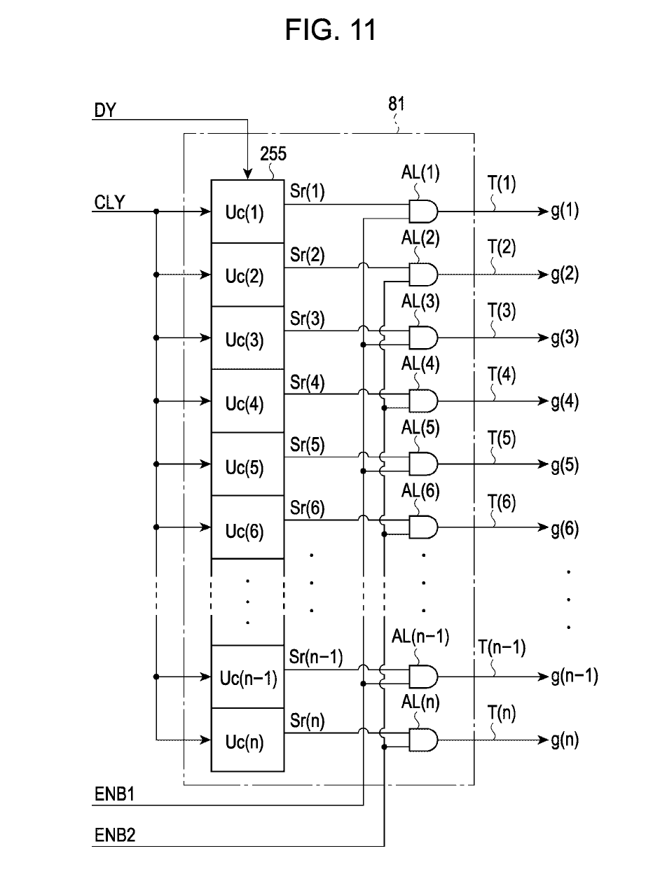

The controller 253 outputs the start pulse DY, a clock signal CLY, an enable signal ENB1, and an enable signal ENB2 to the scanning line driving circuit 81. In this embodiment, the scanning line driving circuit 81 includes a shift register 255 and n AND circuits AL(1) to AL(n), as shown in FIG. 11.

Note that in this embodiment, an even number of 4 or more is applied as n.

The shift register 255 includes an n-stage unit circuit Uc(1) to Uc(n). The unit circuit Uc(i) in each stage corresponds to a respective scanning line T(i). Each AND circuit AL(i) also corresponds to a respective scanning line T(i). Accordingly, the unit circuit Uc(i) in a given stage corresponds to a respective AND circuit AL(i).

Shift signals Sr(i) from each stage of the unit circuit Uc(i) are inputted into respective AND circuits AL(i).

The enable signal ENB1 is inputted into the odd-numbered AND circuits AL(i) of the n AND circuits AL(1) to AL(n). The odd-numbered AND circuits AL(i) output a signal of the logical product of the shift signal Sr(i) and the enable signal ENB1 to a corresponding scanning line T(i) as a selection signal g(i).

The enable signal ENB2 is inputted into the even-numbered AND circuits AL(i) of the n AND circuits AL(1) to AL(n). The even-numbered AND circuits AL(i) output a signal of the logical product of the shift signal Sr(i) and the enable signal ENB2 to a corresponding scanning line T(i) as a selection signal g(i).

Here, in this embodiment, the number of subfield periods SF in a single frame period is set to be an even number. The odd-numbered subfield periods SF and the even-numbered subfield periods SF are set to have different lengths from each other, as shown in FIG. 12. Either of a subfield period SFo and a subfield period SFe may be longer or shorter than the other.

Note that hereinafter, when the odd- and even-numbered subfield periods SF are to be distinguished from each other, the odd-numbered subfield periods SF will be denoted as “subfield periods SFo”, whereas the even-numbered subfield periods SF will be denoted as “subfield periods SFe”. Furthermore, with respect to the start pulse DY, the pulse that defines the start of a subfield period SFo will be denoted as a “start pulse DYo”, whereas the pulse that defines the start of a subfield period SFe will be denoted as a “start pulse DYe”.

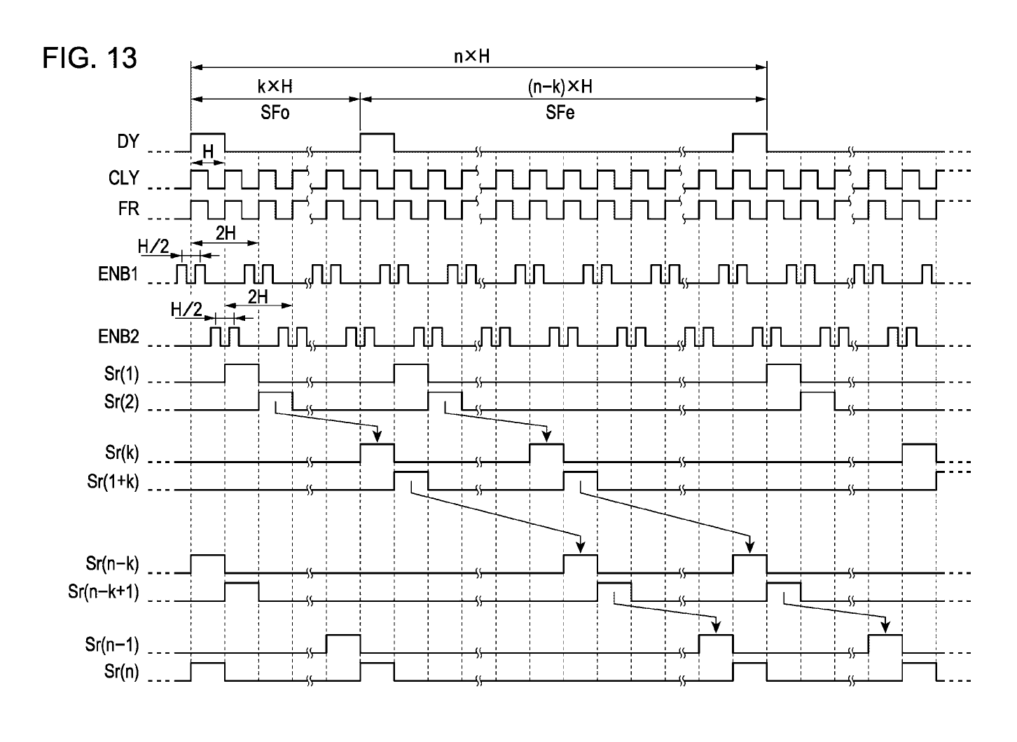

In this embodiment, the start pulse DYo and the start pulse DYe are respectively set so that their pulsewidths have a length (H) equivalent to one cycle of the clock signal CLY, as shown in FIG. 13. The clock signal CLY is set to have a duty ratio of 50%. In this embodiment, the start pulse DYo and the start pulse DYe each rise from Lo level to Hi level in synchronization with the rise of the clock signal CLY from Lo level to Hi level.

Furthermore, the polarity inversion signal FR rises from Lo level to Hi level based on the rise of the clock signal CLY, and changes from the Hi level to the Lo level based on the clock signal CLY changing from the Hi level to the Lo level.

The subfield period SFo is set to a length k×H. Here, k is an odd number no less than 3 and no more than n−1. In other words, in the subfield period SFo, a period in which the clock signal CLY is at Hi level appears k times.

The subfield period SFe is set to a length (n−k)×H. In the subfield period SFe, a period in which the clock signal CLY is at Hi level appears (n−k) times.

Accordingly, adding the lengths of the subfield period SFo and the subfield period SFe results in a length n×H. In other words, in a period obtained by adding the subfield period SFo and the subfield period SFe, a period in which the clock signal CLY is at Hi level appears n times.

The enable signal ENB1 and the enable signal ENB2 each have a cycle of 2H (a cycle twice that of the clock signal CLY). The enable signal ENB1 and the enable signal ENB2 each have a pulsewidth less than H/2.

In the enable signal ENB1 and the enable signal ENB2, two pulses occurring in succession for an interval of H/2 appear every interval of 2H. The two pulses occurring in succession for an interval of H/2 occur before and after, respectively, the timing of the rise of the clock signal CLY from Lo to Hi.

The enable signal ENB1 and the enable signal ENB2 have an electrical phase difference of 180 degrees.

Upon the first start pulse DY being outputted after the liquid crystal apparatus 250 is started up, that start pulse DY is outputted sequentially with each cycle (H) of the clock signal CLY as shift signals Sr(i), from the shift signal Sr(1) to the shift signal Sr(n). The shift signals Sr(i) are sequentially outputted from the shift signal Sr(1) to the shift signal Sr(n) each time the start pulse DY is outputted. Accordingly, the shift signals Sr(i) are outputted cyclically from the n-stage unit circuit Uc(1) to Uc(n).

In this embodiment, the start pulse DYe that defines the start of the subfield period SFe is outputted before the start pulse DYo that defines the start of the subfield period SFo is outputted from the final stage of the unit circuit Uc(n) as the shift signal Sr(i). In this embodiment, the start pulse DYe that defines the start of the subfield period SFe is outputted when the start pulse DYo that defines the start of the subfield period SFo is outputted from the kth-stage unit circuit Uc(k) as a shift signal Sr(k). In other words, the output of the shift signal Sr(k) and the output of the start pulse DYe that defines the start of the subfield period SFe overlap temporally.

Furthermore, the start pulse DYo that defines the start of the subfield period SFo is outputted when the start pulse DYe that defines the start of the subfield period SFe is outputted from the n-kth stage unit circuit Uc(n−k) as a shift signal Sr(n−k). In other words, the output of the shift signal Sr(n−k) and the output of the start pulse DYo that defines the start of the subfield period SFo overlap temporally.

Accordingly, in this embodiment, the shift signal Sr(i) and a shift signal Sr(n−k+i) are outputted during the subfield period SFo in a state in which those signals overlap temporally. Furthermore, the shift signal Sr(i) and a shift signal Sr(i+k) are outputted during the subfield period SFe in a state in which those signals overlap temporally.

At this time, the odd-numbered shift signals Sr(i) and the even-numbered shift signals Sr(i) overlap temporally. However, a temporal overlap between odd-numbered shift signals Sr(i) is avoided. Similarly, a temporal overlap between even-numbered shift signals Sr(i) is avoided as well.

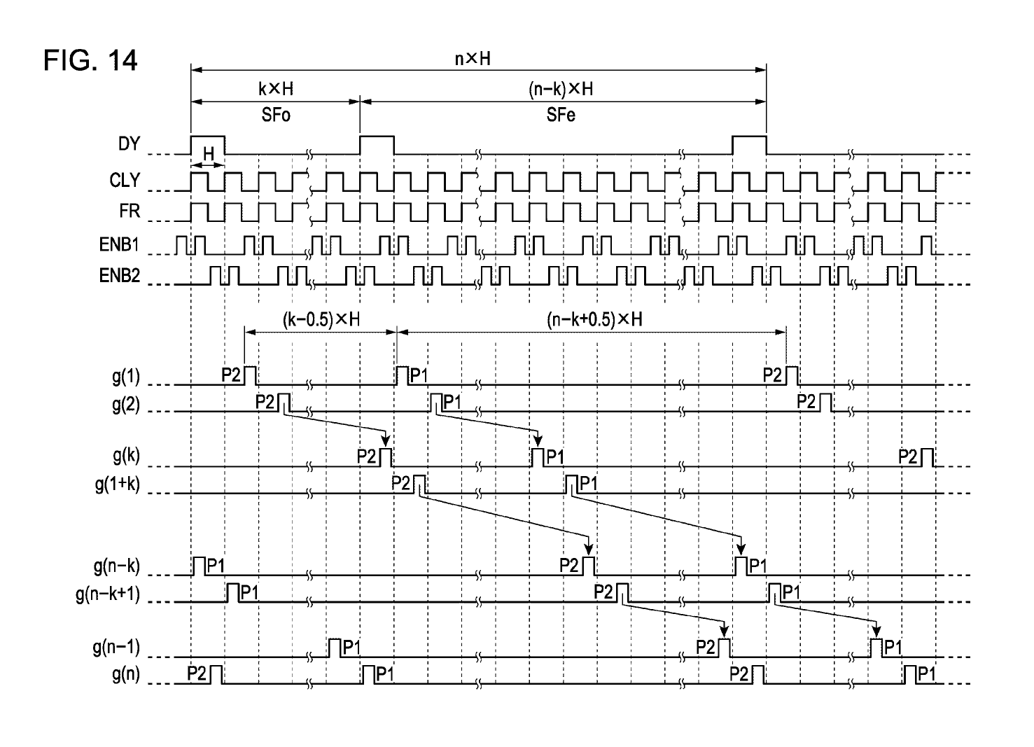

Here, the enable signal ENB1 and the enable signal ENB2 have an electrical phase difference of 180 degrees. Accordingly, even if the odd-numbered shift signals Sr(i) and the even-numbered shift signals Sr(i) overlap temporally, the n selection signals g(i) do not overlap temporally, as shown in FIG. 14.

In the subfield period SFo, a selection signal g(n) is outputted after a selection signal g(n−k), a selection signal g(n−k+1) is outputted after the selection signal g(n), and a selection signal g(1) is outputted after the selection signal g(n−k+1). Once a selection signal g(n−k−1) is outputted after a selection signal g(n−1), the subfield period SFo ends.

Meanwhile, in the subfield period SFe, a selection signal g(k) is outputted after the selection signal g(n), the selection signal g(1) is outputted after the selection signal g(k), and a selection signal g(1+k) is outputted after the selection signal g(1). Once the selection signal g(n−1) is outputted after the selection signal g(n−k−1), the subfield period SFe ends.

In other words, in this embodiment, the scanning line driving circuit 81 outputs a selection signal g(i+k) after the selection signal g(i), and then outputs a selection signal g(i+1). However, if i+k exceeds n, i+k is replaced with i+k−n.

According to the above configuration, the intervals at which pulses occur in a single selection signal g(i) can be made different in an alternating manner. In this embodiment, a pulse P1 and a pulse P2 appear alternately in a single selection signal g(i); in the case where the pulse P1 occurs after the pulse P2, the interval between the pulse P1 and the pulse P2 is (k−0.5)×H, whereas in the case where the pulse P2 occurs after the pulse P1, the interval between the pulse P1 and the pulse P2 is (n−k+0.5)×H. In this embodiment, the pulse P1 corresponds to the period in which the polarity inversion signal FR is at the Hi level, and the pulse P2 corresponds to the period in which the polarity inversion signal FR is at the Lo level.

As a result, in each of the n pixel rows 88, a positive-polarity voltage can be applied to the liquid crystal 75 between the pixel electrode 105 and the opposing electrode 125 during the period (k−0.5)×H, and a negative-polarity voltage can be applied to the liquid crystal 75 between the pixel electrode 105 and the opposing electrode 125 during the period (n−k+0.5)×H.

Accordingly, for each pixel 65, a subfield period SF that puts the liquid crystal 75 into an on state using a positive-polarity voltage and a subfield period SF that puts the liquid crystal 75 into an on state using a negative-polarity voltage can be given different lengths from each other.

Although the subfield period SF in which a positive-polarity voltage is applied and the subfield period SF in which a negative-polarity voltage is applied are set to different lengths from each other in this embodiment, these lengths may be set arbitrarily in accordance with differences in the characteristics between the opposing electrode substrate and the pixel electrode substrate (for example, the work functions and so on thereof). There are also situations where the subfield period SF in which a positive-polarity voltage is applied and the subfield period SF in which a negative-polarity voltage is applied have lengths that are equal to each other, depending on the relationship between the setting values of the positive-polarity and negative-polarity driving voltages, the setting value of an LCCOM voltage, and differences in the characteristics of the substrates (described later). In this manner, adjusting the subfield periods makes it possible to prevent burn-in even in cases where the driving voltage is swapped between positive-polarity and negative-polarity.

In this embodiment, the enable signal ENBX rises from Lo level to Hi level based on the first change point of the clock signal CLY following the rise of the start pulse DY.

A single cycle of the enable signal ENBX is set to be equal to the pulsewidth of the selection signal g(i). After rising from Lo level to Hi level, the enable signal ENBX sequentially rises from Lo level to Hi level based on each rise of the selection signals g(1) to g(n). Accordingly, the enable signal ENBX has n+1 rising pulses within a single subfield period SF.

Note that in this embodiment, one cycle of an enable signal ENBX corresponds to a single horizontal period.

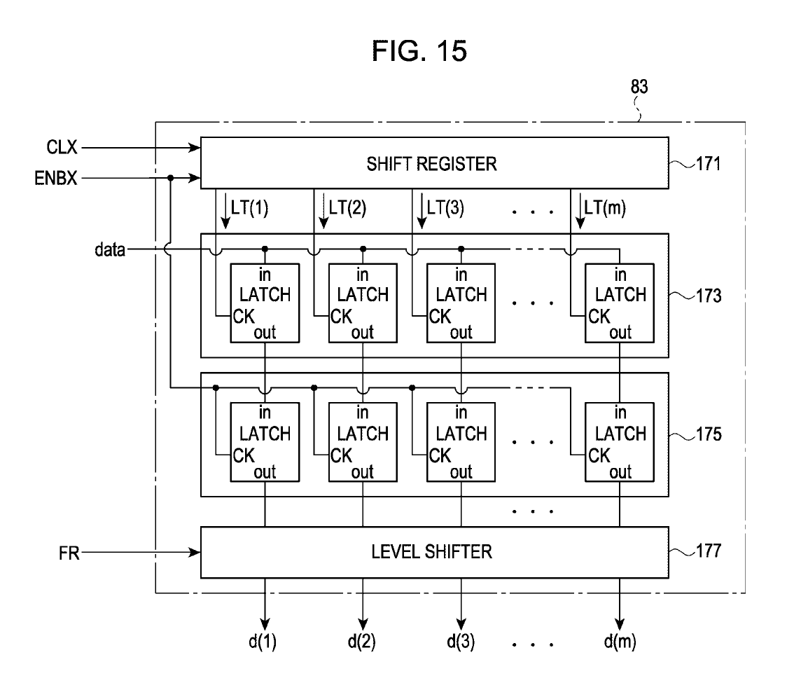

As shown in FIG. 15, the signal line driving circuit 83 includes a shift register 171, a first latch circuit 173, a second latch circuit 175, and a level shifter 177. The enable signal ENBX and the clock signal CLX are inputted into the shift register 171.

Output signals from the shift register 171 (a latch signal LT(1) to a latch signal LT(m)) and the subfield driving data sfdata are inputted into the first latch circuit 173.

The output signals from the first latch circuit 173 and the enable signal ENBX are inputted into the second latch circuit 175.

The output signals from the second latch circuit 175 and the polarity inversion signal FR are inputted into the level shifter 177.

Data signals d(1) to d(m) are outputted from the level shifter 177. The data signal d(1) is, as shown in FIG. 5, supplied to the signal line S(1). The data signal d(2) is supplied to the signal line S(2), and the data signal d(m) is supplied to the signal line S(m).

The shift register 171 shifts the enable signal ENBX at each change point of the clock signal CLX, sequentially outputting those shifted signals as the latch signals LT(1), LT(2), LT (3) and so on up to LT(m).

The first latch circuit 173 sequentially latches the subfield driving data sfdata, which is a binary signal, based on the change of a latch signal LT(j) from the Hi level to the Lo level.

The second latch circuit 175 latches all of the pieces of subfield driving data sfdata latched by the first latch circuit 173 at once, based on the enable signal ENBX. The pieces of subfield driving data sfdata latched by the second latch circuit 175 are supplied to the signal lines S(1) to S(m), respectively, as data signals d(1) to d(m), via the level shifter 177.

The level shifter 177 selects a potential corresponding to the positive-polarity voltage as the potential of the data signals d(1) to d(m) when the polarity inversion signal FR is at Hi level. Meanwhile, the level shifter 177 selects a potential corresponding to the negative-polarity voltage as the potential of the data signals d(1) to d(m) when the polarity inversion signal FR is at Lo level. Regardless of whether the absolute values of the driving voltages at the positive and negative polarities are the same or different, there is no change in the required number of power sources. Accordingly, in this embodiment, reduced costs can be realized without complicating the driving circuit even in cases where the absolute values of the driving voltages at the positive and negative polarities are different.

With the liquid crystal apparatus 85, either the on voltage for putting the liquid crystal 75 into an on state or the off voltage for putting the liquid crystal 75 into an off state is selected in accordance with tonal data. With the normally black mode, a bright display is realized when an on voltage, which is a driving voltage that is greater than or equal to the saturation voltage, is applied, whereas a dark display is realized when an off voltage, which is a driving voltage that is less than or equal to the threshold voltage, is applied. Conversely, with the normally white mode, a dark display is realized when an on voltage is applied, whereas a bright display is realized when an off voltage is applied.

With the liquid crystal apparatus 85, a positive-polarity voltage and a negative-polarity voltage are set as on voltages for putting the liquid crystal 75 into an on state, and either the positive-polarity voltage or the negative-polarity voltage is selected as the on voltage in a single subfield.

The positive-polarity voltage corresponds to the potential difference between the pixel electrode 105 and the opposing electrode 125 in the case where the potential of the pixel electrode 105 is higher than the potential of the opposing electrode 125.

Meanwhile, the negative-polarity voltage corresponds to the potential difference between the pixel electrode 105 and the opposing electrode 125 in the case where the potential of the pixel electrode 105 is lower than the potential of the opposing electrode 125.

In this embodiment, the opposing electrode 125 is set to have the same potential for the positive-polarity voltage and the negative-polarity voltage. Furthermore, in this embodiment, the absolute value of the positive-polarity voltage and the absolute value of the negative-polarity voltage are set to values that are different from each other.

With the liquid crystal apparatus 85, a reference voltage Vc is set as the off voltage for putting the liquid crystal 75 into an off state.

Incidentally, the voltage LCcom applied to the opposing electrode 125 is set to be lower than the reference voltage Vc. This is because with an n-channel transistor, parasitic capacitance arising between the gate/drain electrodes causes the occurrence of feedthrough, where the potential of the drain (pixel electrode 105) drops at the time of a state change from on to off. Assuming a case where the voltage LCcom is caused to match the reference voltage Vc, the rms voltage of a liquid crystal element arising due to a negative-polarity write becomes slightly larger than the rms voltage arising due to a positive-polarity write due to the feedthrough (in the case of an re-channel transistor). Accordingly, the voltage LCcom is set so as to be offset lower than the reference voltage Vc, to an appropriate value in order to eliminate the influence of feedthrough. However, if the influence of feedthrough can be ignored, the voltage LCcom and the reference voltage Vc may be set to equal values.

The aforementioned operations for latching the subfield driving data sfdata(j) and operations for outputting the data signal d(j) are repeated a number of times equivalent to the number of scanning lines T(i) (in this embodiment, n times) within a single subfield period SF. Through this, the image formation within a single subfield period SF is completed. Repeating these operations from the subfield period SF1 to the subfield period SF32 makes it possible to form a single frame's worth of an image.

In this embodiment, a tonal display for a single frame's worth of an image can be carried out within a single frame period by selectively controlling the driving of the liquid crystal 75 at the subfield period SF level. The liquid crystal enters an on state or an off state in response to the selection of the on voltage or the off voltage in each subfield. The strength of the transmitted light changes depending on the state of the response of the liquid crystal, and tones are expressed based on integrated value of the transmitted light strength within a single frame period. To be more specific, with a normally black liquid crystal, the maximum tone can be expressed when the entire liquid crystal is in an on state in a single frame period, whereas a 0 tone can be expressed when the entire liquid crystal is in an off state in a single frame period. When two or more of the transient states, or the on state and the off state, coexist in a single frame period, half-tones can be expressed. Accordingly, it is possible to display various tones by controlling the ratio between the periods in which an on voltage is applied and the periods in which an off voltage is applied within a single frame period, and controlling the arrangement of the subfield periods in which an on voltage is applied and the subfield periods in which an off voltage is applied.

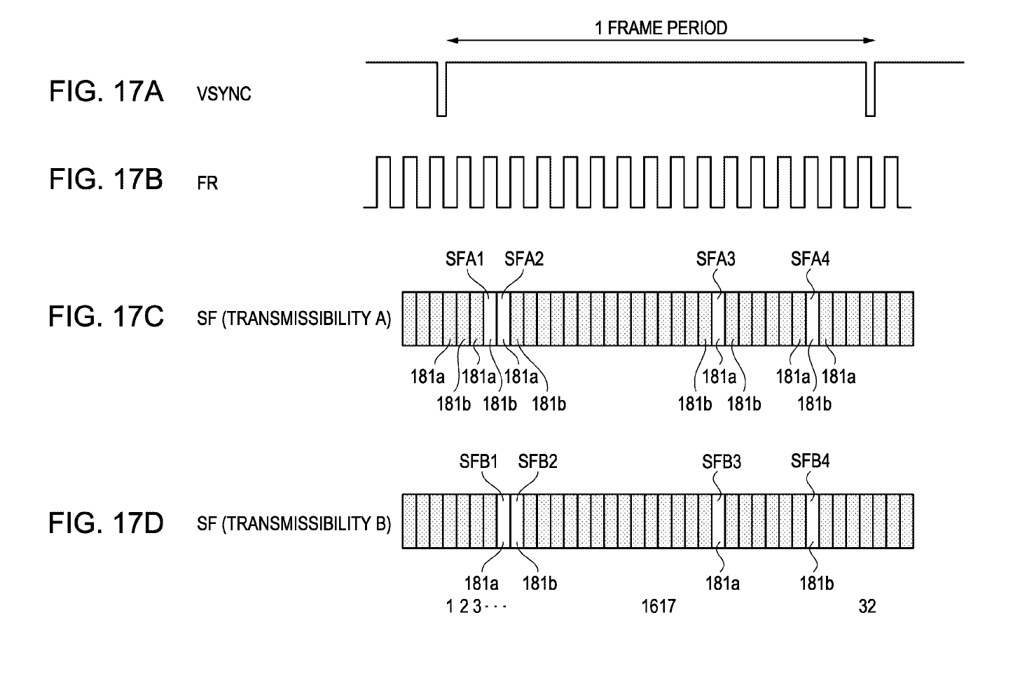

In this embodiment, in a single frame period, the period in which an on voltage is applied to the liquid crystal 75, or in other words, the period in which a saturation voltage is applied between the pixel electrode 105 and the opposing electrode 125 has, as shown in FIG. 17, a positive-polarity period 181a having a positive-polarity voltage and a negative-polarity period 181b having a negative-polarity voltage arranged in an alternating manner. Although the length of the positive-polarity period 181a and the length of the negative-polarity period 181b are illustrated in FIG. 17 as being equal to each other, the length of the positive-polarity period 181a and the length of the negative-polarity period 181b are in actuality not equal to each other, as described with reference to FIG. 14.

FIG. 17 is a timing chart illustrating the positive-polarity and negative-polarity periods. FIG. 17A and FIG. 17B illustrate the timings of the vertical synchronization signal VSYNC and the polarity inversion signal FR, respectively, whereas FIG. 17C and FIG. 17D illustrate an example of the arrangement of subfield periods within a certain frame period. The horizontal axes in FIG. 17A to FIG. 17D all represent time. In FIG. 17, a single frame period is divided into 32 subfield periods SF. Subfield periods SF in which an off voltage is applied to the liquid crystal 75, or in other words, in which the threshold voltage is applied between the pixel electrode 105 and the opposing electrode 125, are hatched. However, subfield periods SF in which an on voltage is applied to the liquid crystal 75 are not hatched. Note that FIG. 17 illustrates an example in which an on voltage is applied to the liquid crystal 75 in four subfield periods SF within a single frame period.

In the example shown in FIG. 17C, of the four subfield periods SFA1 to SFA4 in which an on voltage is applied to the liquid crystal 75, two of the subfield periods, or SFA2 and SFA3, are allocated as positive-polarity periods 181a. Of the four subfield periods SF, the two remaining subfield periods, or SFA1 and SFA4, are allocated as negative-polarity periods 181b. Meanwhile, in the example shown in FIG. 17D, of the four subfield periods SFB1 to SFB4 in which an on voltage is applied to the liquid crystal 75, two of the subfield periods, or SFB1 and SFB3, are allocated as positive-polarity periods 181a. Of the four subfield periods SF, the two remaining subfield periods, or SFB2 and SFB4, are allocated as negative-polarity periods 181b. The subfield periods SFA1 and SFA2 are arranged to be temporally consecutive, and the subfield periods SFB1 and SFB2 are arranged to be temporally consecutive. Furthermore, the interval between the subfield periods SFA2 and SFA3, the interval between the subfield periods SFA3 and SFA4, and the interval between the subfield period SFA4 and a subfield period SFA1 in the next frame are all arranged so as to be temporally separate from each other to a degree whereby the liquid crystal responses in these subfield periods do not act on each other. In other words, the total of the integrated values of the transmissibilities in the two subfield periods SFA3 and SFA4 is equivalent to double the integrated value of the transmissibility of a single subfield period. The same applies to the subfield periods SFB1 to SFB4.

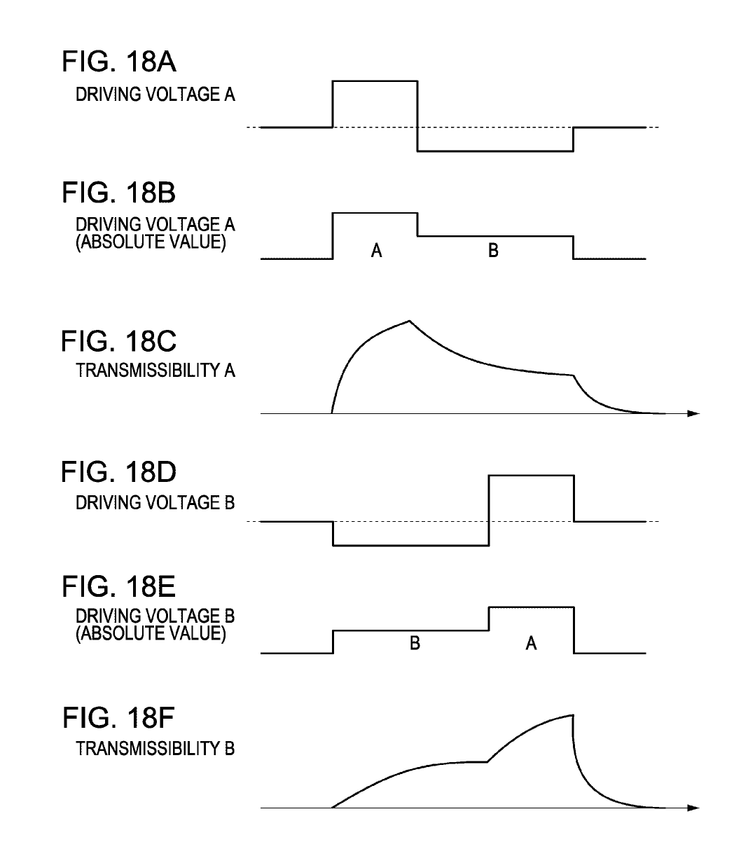

However, because the total of the integrated values of the transmissibilities of the subfield periods SFA1 and SFA2 and the total of the integrated values of the transmissibilities of the subfield periods SFB1 and SFB2 differ from each other, with the arrangement of the subfield periods SFA1 to SFA4 indicated in FIG. 17C and the arrangement of the subfield periods SFB1 to SFB4 indicated in FIG. 17D, integrating a single frame period results in a transmissibility A and a transmissibility B to be different from each other. The reason for this will be described using FIG. 18.

FIG. 18A illustrates a voltage waveform when a positive-polarity on voltage and a negative-polarity on voltage are applied to the liquid crystal 75 in that order; FIG. 18B illustrates the absolute value in the case illustrated in FIG. 18A; and FIG. 18C illustrates the transmissibility change in the case illustrated in FIG. 18A. Meanwhile, FIG. 18D illustrates a voltage waveform when a negative-polarity on voltage and a positive-polarity on voltage are applied to the liquid crystal 75 in that order; FIG. 18E illustrates the absolute value in the case illustrated in FIG. 18D; and FIG. 18F illustrates the transmissibility change in the case illustrated in FIG. 18D.

As described earlier, the positive-polarity voltage and the negative-polarity voltage are set to voltage values with different absolute values from each other. In the example shown in FIG. 18, the absolute value of the positive-polarity voltage is set to be higher than the absolute value of the negative-polarity voltage. Furthermore, subfields allocated as positive-polarity periods are set to be temporally shorter than subfields allocated as negative-polarity periods. Doing so makes it possible to prevent imbalances in the charges applied to the liquid crystal panel, thereby preventing the occurrence of burn-in. In this embodiment, the number of subfields in which an on voltage is applied during a positive-polarity period is set to be equal to the number of subfields in which an on voltage is applied during a negative-polarity period. Doing so makes it possible to effectively prevent burn-in even when changing the number of on voltages to express different tone levels.

The example indicated in FIG. 18A, FIG. 18B, and FIG. 18C correspond to the case of FIG. 17D, in which a positive-polarity on voltage and a negative-polarity on voltage are applied in that order to the liquid crystal 75, and the example indicated in FIG. 18D, FIG. 18E, and FIG. 18F correspond to the case of FIG. 17C, in which a negative-polarity on voltage and a positive-polarity on voltage are applied in that order to the liquid crystal 75. As can be seen by comparing FIG. 18C and FIG. 18F, the amount of transmissibility change per unit time is greater for the transmissibility in which a higher voltage is applied first. Accordingly, in the case where the transitions of the absolute values of the applied voltages differ even if the totals of the rms values of the applied voltages are equal, the transitions of the transmissibilities are different as well in response thereto, and as a result, the integrated values of the transmissibilities (corresponding to the area of the transmissibilities in FIG. 18C and FIG. 18F) differ as well. For example, a higher transmissibility can be realized by first applying a positive-polarity voltage set to a high voltage than by first applying a negative-polarity voltage set to a low voltage. In the case where the positive-polarity voltage and the negative-polarity voltage are equal, the transmissibility transition is the same even if the polarity order is switched and thus the transmissibility does not change; however, causing the driving voltages to differ between positive and negative polarities in this manner makes it possible to significantly increase the number of tones that can be expressed.

Although the order of subfields in which an on voltage is continuously applied is switched in this embodiment as shown in FIG. 17, the invention is not limited thereto. It is only necessary for the liquid crystal to be in a transient responsive state, and the order of subfields that are separated within the liquid crystal response time may be switched.

Furthermore, although the positive-polarity period and the negative-polarity period are alternated from subfield to subfield in a single frame period, the invention is not limited thereto. For example, the configuration may be such that in a single frame period, a positive-polarity period may continue for multiple subfields and a negative-polarity period may continue for multiple subfields thereafter, and this is repeated. In this case, the same effects can be obtained at the areas in which the polarity switches.

Although the VA driving method is employed as the driving method for the liquid crystal 75 in this embodiment, the driving method is not limited thereto. Various methods can be employed in the driving method of the liquid crystal 75, such as the TN (Twisted Nematic) method, the IPS (In Plane Switching) method, the FFS (Fringe Field Switching) method, and so on.

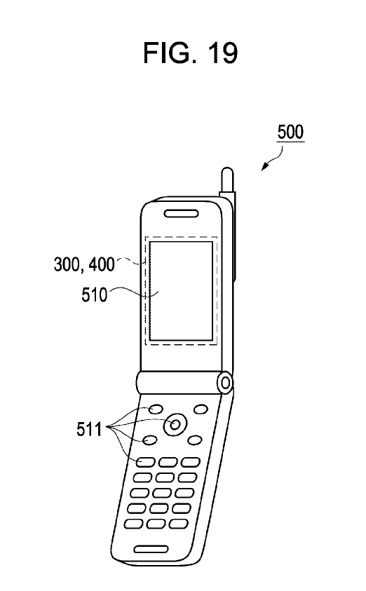

The liquid crystal apparatus 85, serving as an example of the above-described electro-optical apparatus, can be applied to, for example, a display unit 510 in an electronic device 500, as shown in FIG. 19. The electronic device 500 is a mobile telephone. The electronic device 500 includes operational buttons 511. The display unit 510 is capable of displaying various types of information, including content inputted using operational buttons 511, communication information, and so on. With this electronic device 500, the liquid crystal apparatus 85 is applied in the display unit 510, and thus it is possible to effectively reduce burn-in in the liquid crystal 75 of the display unit 510.

Note that the electronic device 500 is not limited to a mobile telephone, and various electronic devices can be given as examples thereof, including a mobile computer, digital still camera, digital video camera, vehicle-installed device such as a display device for a car navigation system, audio device, or the like.

What is claimed is:

1. An electro-optical apparatus comprising:
a switching transistor provided at the intersecting point of a scanning line and a data line;
a pixel electrode connected to the switching transistor and to which a potential is supplied from the data line via the switching transistor;
an opposing electrode, an electro-optical layer to which an electrical field generated between the pixel electrode and the opposing electrode is applied; and
a driving circuit that drives the scanning line and the data line,
wherein the electro-optical apparatus controlling the light transmission of the electro-optical layer and displaying multiple tones by dividing at least part of a frame period into multiple subfield periods and by selecting, on a subfield period-by-subfield period basis, one of an on voltage and an off voltage as the driving voltage to apply between the pixel electrode and the opposing electrode in order to generate the optical field;
the on voltage is selected from among a positive-polarity voltage and a negative-polarity voltage, the positive-polarity voltage being the driving voltage in the case where the potential of the pixel electrode is higher than the potential of the opposing electrode, and the negative-polarity voltage being the driving voltage in the case where the potential of the pixel electrode is lower than the potential of the opposing electrode;
the off voltage is the driving voltage in the case where the potential of the pixel electrode is approximately equal to the potential of the opposing electrode; and
the driving circuit determines, in accordance with the tone to be displayed, the ratio between the application period of the on voltage and the application period of the off voltage during the frame period and the arrangement of the multiple subfield periods in which the on voltage is to be applied and the arrangement of the multiple subfield periods in which the off voltage is to be applied, and the absolute value of the positive-polarity voltage and the absolute value of the negative-polarity voltage are different.

2. The electro-optical apparatus according to claim 1, wherein the frame period includes multiple positive-polarity periods in which the positive-polarity voltage is selected as the on voltage and multiple negative-polarity periods in which the negative-polarity voltage is selected as the on voltage, and the length of the subfield period contained in the positive-polarity period and the length of the subfield period contained in the negative-polarity period differ from each other.

3. The electro-optical apparatus according to claim 2,
wherein the subfield period contained in the positive-polarity period is longer than the subfield period contained in the negative-polarity period; and
the absolute value of the positive-polarity voltage is less than the absolute value of the negative-polarity voltage.

4. The electro-optical apparatus according to claim 2,
wherein the subfield period contained in the positive-polarity period is shorter than the subfield period contained in the negative-polarity period; and
the absolute value of the positive-polarity voltage is greater than the absolute value of the negative-polarity voltage.

5. The electro-optical apparatus according to claim 2, wherein in the frame period, the subfield periods in which the positive-polarity voltage is selected as the on voltage and the subfield periods in which the negative-polarity voltage is selected as the on voltage are arranged in an alternating manner.

6. The electro-optical apparatus according to claim 1, wherein in a first frame period and a second frame period in which the numbers of multiple subfield periods in which the on voltage is applied are equal, the driving circuit arranges the multiple subfield periods in which the on voltage is applied to that the integrated value of the light transmission in the first frame period corresponds to a first tone and the integrated value of the light transmission of the second frame period corresponds to a second tone that is different from the first tone.

7. The electro-optical apparatus according to claim 6,
wherein in the first frame period, the response of the electro-optical layer in a first subfield period in which an on voltage that is the positive-polarity voltage is applied and the response of the electro-optical layer in a second subfield period in which an on voltage that is the negative-polarity voltage is applied affect each other;
in the second frame period, the response of the electro-optical layer in a third subfield period in which an on voltage that is the positive-polarity voltage is applied and the response of the electro-optical layer in a fourth subfield period in which an on voltage that is the negative-polarity voltage is applied affect each other;
the first subfield period is arranged in a location that is temporally earlier than the second subfield period; and
the third subfield period is arranged in a location that is temporally later than the fourth subfield period.

8. An electronic device comprising the electro-optical apparatus according to claim 1.

9. A driving method for an electro-optical apparatus, the electro-optical apparatus comprising a switching transistor provided at the intersecting point of a scanning line and a data line, a pixel electrode connected to the switching transistor and to which a potential is supplied from the data line via the switching transistor, an opposing electrode, an electro-optical layer to which an electrical field generated between the pixel electrode and the opposing electrode is applied, and a driving circuit that drives the scanning line and the data line,
the electro-optical apparatus controlling the light transmission of the electro-optical layer and displaying multiple tones by dividing at least part of a frame period into multiple subfield periods and by selecting, on a subfield period-by-subfield period basis, one of an on voltage and an off voltage as the driving voltage to apply between the pixel electrode and the opposing electrode in order to generate the optical field,
wherein the on voltage is selected from among a positive-polarity voltage and a negative-polarity voltage, the positive-polarity voltage being the driving voltage in the case where the potential of the pixel electrode is higher than the potential of the opposing electrode, and the negative-polarity voltage being the driving voltage in the case where the potential of the pixel electrode is lower than the potential of the opposing electrode;
the off voltage is the driving voltage in the case where the potential of the pixel electrode is approximately equal to the potential of the opposing electrode; and
the ratio between the application period of the on voltage and the application period of the off voltage during the frame period, and the arrangement of the multiple subfield periods in which the on voltage is to be applied and the arrangement of the multiple subfield periods in which the off voltage is to be applied, are determined in accordance with the tone to be displayed, and the absolute value of the positive-polarity voltage and the absolute value of the negative-polarity voltage are different from each other.
